(19) United States
(12) Patent Application Publication
(10) Pub. No.: US 2020/0211446 A1
(43) Pub. Date: Jul. 2, 2020

(54) Display Panels with Embedded Control System

(71) Applicant: Ultravision Technologies, LLC, Dallas, TX (US)

(72) Inventor: Chris Mays, Coppell, TX (US)

(21) Appl. No.: 16/564,521

(22) Filed: Sep. 9, 2019

Related U.S. Application Data
(60) Provisional application No. 62/729,299, filed on Sep. 10, 2018.

(51) Int. Cl. G09G 3/32; G09F 9/33

(52) U.S. Cl. CPC G09G 3/32; G09F 9/33; G09G 2320/0666; G09G 2360/141; G09G 2320/0626; G09G 2310/0275

(57) ABSTRACT

A modular display panel includes a printed circuit board, a casing, a plurality of light-emitting diodes (LEDs) attached to a first side of the printed circuit board, a data controller comprising data processing and data rendering circuits attached directly to a second side of the printed circuit board, and a sensor circuit. The data controller is configured to determine a portion of an input data signal to be output by the plurality of LEDs.

### CROSS-REFERENCE TO RELATED APPLICATIONS

This application claims the benefit of U.S. Provisional Application No. 62/729,299, filed on Sep. 10, 2018 which application is hereby incorporated herein by reference.

### TECHNICAL FIELD

The present invention relates generally to a display panel and system, and, in particular embodiments, to a display system having a modular display panel with an embedded control system.

### BACKGROUND

Generally, large displays (e.g., billboards), such as those commonly used for advertising in cities and along roads, as well as indoor places such as airports, malls, subway terminals, have one or more pictures and/or text that are to be displayed under various light and weather conditions. As technology has advanced and introduced new lighting devices such as the light-emitting diode (LED), such advances have been applied to large displays. An LED display is a flat panel display, which uses an array of light-emitting diodes. A large display may be made of a single LED display or a panel of smaller LED panels. LED panels may be conventional panels made using discrete LEDs or surface-mounted device (SMD) panels. Most outdoor screens and some indoor screens are built around discrete LEDs, which are also known as individually mounted LEDs. A cluster of red, green, and blue diodes, or alternatively, a tri-color diode, is driven together to form a full-color pixel, usually square in shape. These pixels are spaced evenly apart and are measured from center to center for absolute pixel resolution.

A disadvantage of the large displays is the requirement of an external data receiver box, which receives the media file, determines the image output of each LED panel, encodes the file for each separate LED panel, and transmits the encoded media file to one or more of the LED panels. Due to the complexity of handling those tasks for all of the LED panels, the data receiver box requires a very high performance processor. The data receiver box, therefore, is often a bulky component requiring labor-intensive configuration to carry out these intensive steps.

A second disadvantage is that any changes to the LED panels—whether addition, removal, or replacement—requires further labor-intensive reconfiguration at the data receiver box.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a modular display panel in accordance with an embodiment of the present invention;

FIG. 2 illustrates one LED display panel of the preassembled display unit comprising an input cable connector and an output cable connector, sensors, and a data controller;

FIG. 3 illustrates two LED display panels next to each other and connected through the connectors such that the output cable of the left display panel is connected with the input cable of the next display panel;

FIGS. 4A-4C illustrate various embodiments of a modular multi-panel preassembled display unit comprising a plurality of LED display panels connected together using the aforementioned connectors;

FIGS. 5A-5D illustrate top-down views of an LED display unit emphasizing different components;

FIGS. 6A-6E illustrate an LED display panel in accordance with alternative embodiments of the present invention;

FIG. 7A illustrates a system diagram schematic of an LED display panel in accordance with an embodiment of the present invention; and

FIG. 7B illustrates a system diagram of the physical circuit components attached to the PCB in accordance with the FIG. 7A embodiment.

### DETAILED DESCRIPTION OF ILLUSTRATIVE EMBODIMENTS

In the following discussion, exterior displays are used herein for purposes of example. It is understood that the present disclosure may be applied to lighting for any type of interior and/or exterior display.

The large display unit includes a plurality of individual light-emitting diode (LED) display panels wherein each LED display panel displays a portion of the entire image. As needs and purposes change, the dimensions of the display unit may change—that is, individual LED display panels may be added or removed. Currently, any changes to the LED display panels requires a labor-intensive reconfiguration of a data receiver box, which encodes the entire image signal into individual pieces assigned to each LED display panel. This also requires the data receiver box to contain a high level of processing power, which often causes the data receiver box to be very large, expensive, or both.

The invention described herein in various embodiments removes that processing requirement from the data receiver box and uses a smaller, more versatile, and less expensive processor in each of the LED display panels. As such, each LED display panel is able to determine its location within the display unit and determine its portion of the entire image signal to display. The data receiver box is replaced with merely a “dumb” receiver box, which passes the input data signal containing the entire image signal from the source computer to the LED display panels. Further, the LED display panels may be connected to the receiver box and to one another in a variety of ways allowing for communications of the input data signal as well as information about the dimensions of the display unit as well as the individual locations within the display unit.

When individual LED display panels are added, removed, or replaced, the final array of LED display panels is able to communicate internally in order for each LED display panel to determine its particular output of the image signal.

Embodiments of the invention provide LED display panels, each of which provides a completely self-contained building block. Advantageously, in various embodiments, each LED display panel is able to determine the portion of the image to display from the input data signal. The data receiver box along with its expensive high performance processor is no longer necessary, and a simple receiver box with a less expensive processor can be used instead.

Consequently, replacement of defective units is very simple, and in addition, no technical personal is required to reconfigure the data receiver box. Therefore, a person with lower skill can easily remove and replace a defective LED display panel and get the display system working again. Accordingly, embodiments of the present invention significantly reduce the operating cost of the display unit.

These display units are designed to be weather proof, without a heavy cabinet or surrounding enclosure, although it is understood that the present disclosure may be applied to lighting for any type of interior and/or exterior display. The lightweight design allows for easier installation and maintenance, thus lowering total cost of ownership.

Embodiments of the invention provide building block LED display panels that are configurable with future expansion, reduction, or rearrangement. Each panel is configured to communicate with one another to determine the dimensions of the entire display, to determine its physical position in the entire display, and to determine its portion to output of the entire media display. Installation is fast and easy with very little down-time, which allows any electronic message to be presented more quickly.

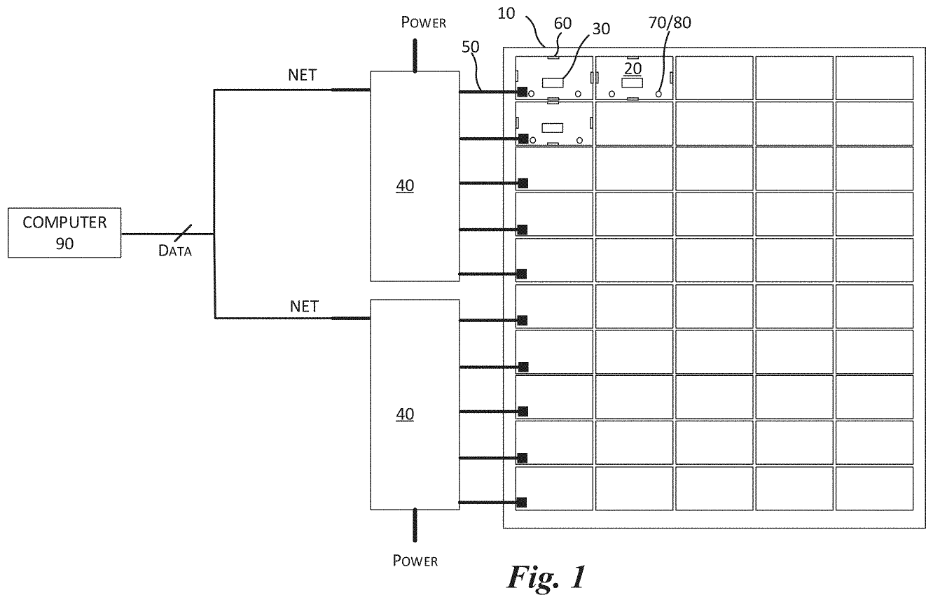

FIG. 1 illustrates a modular display panel in accordance with an embodiment of the present invention. The multi-panel modular preassembled display unit 10 comprises a plurality of LED display panels 20. In various embodiments described herein, the LED display panels 20 are attached to a frame or skeletal structure (not shown) that provides the framework for supporting the LED display panels 20. The LED display panels 20 are stacked next to each other and securely attached to the frame.

In various embodiments, the preassembled display unit 10 may be used in a window display, billboard display, or other types of displays such as video walls, personal display screens and others. The preassembled display unit 10 may be sound enabled, for example, coupled to a common sound system in some embodiments. The sound system may be activated or deactivated depending on external conditions such as the presence of a user in some embodiments.

Referring to FIG. 1, the LED display panels 20 are arranged in an array of rows and columns to form a larger integrated display surface. Each of the LED display panels 20 may include LEDs arranged in a plurality of rows and columns. For example, each of the LED display panels 20 may include at least 50 rows and at least 50 columns.

The size of the individual panels 20 may vary—for example, they may be about 0.5′×0.5′, 2′×3′, 3′×4′, as examples, as well as about 0.25 m×0.25 m, 0.5 m×0.5 m, 0.5 m×1 m, 1 m×1 m, as additional examples. For example, a display system could include 336 panels that are each 1′×2′ in dimension to create a 14′×48′ display. The display may be sized in metric system in other embodiments and may have aspect ratios of 1:1, 2:1, 4:3, 16:9, as examples. In another embodiment, a display system could include 320 LED display panels 20 arranged in ten rows and thirty-two columns. In other embodiments, displays with any other number of panels can be used.

The frame may include support structures for the electrical cables, input/output cable connectors, an electrical power box powering the LED display panels 20, a receiver box 40, data, and communication to the LED display panels 20.

As will be further described in greater detail, each LED display panel 20 includes a data controller 30 that allows the receiver box 40 to do less data processing. It should be noted that each LED display panel 20 includes a data controller 30 and a sensor 60 although not necessarily shown throughout the figures.

Referring again to FIG. 1, a first LED display panel 20 in each row receives an input data signal from a receiver box 40 and has an output data connection to a next LED display panel 20 in the row through connectors discussed below. Each further LED display panel 20 provides data to a next adjacent LED display panel until an LED display panel 20 at the end of the row is reached. The power line is run across each row to power the LED display panels 20 in that row.

FIG. 1 further illustrates a source of the input data signal that is sent to a receiver box 40, which sends the input data signal to the first LED display panel 20 in each row of the preassembled display unit 10 through connector 50. In an embodiment, computer 90 provides the source of the input data signal, which may be sent directly or through a local area network (or equivalent wireless network) to the receiver box 40. Advantageously, the input data signal is sent to the other LED display panels 20 without processing at the receiver box 40 through the connectors as described below.

In one or more embodiments, the preassembled display unit 10 may have an alternative arrangement and connectivity between LED display panels 20 such that the LED display panel 20 that receives an input data signal may send the input data signal to other LED display panels 20 without altering the input data signal. For example, the LED display panel 20 may send other information to the other LED display panels 20, such as information from the sensor(s) 60 and/or arrangement and dimension information of the preassembled display unit 10. As such, the receiver box 40 may send the input data signal to one or more LED display panels 20, which will in turn send the input data signal to other LED display panels 20 to send the input data signal to other LED display panels 20, and so on, until all LED display panels 20 on all rows have received the input data signal.

In various embodiments, the receiver box 40 is configured to provide power, data, and communication to the LED display panels 20. The receiver box 40 need not include a data processing circuit to process the data to be displayed and provide to the individual panels because each of the LED display panels 20 has its own data processing circuitry as part of the data controller 30 to determine its portion of the image to display from the entire image for each frame.

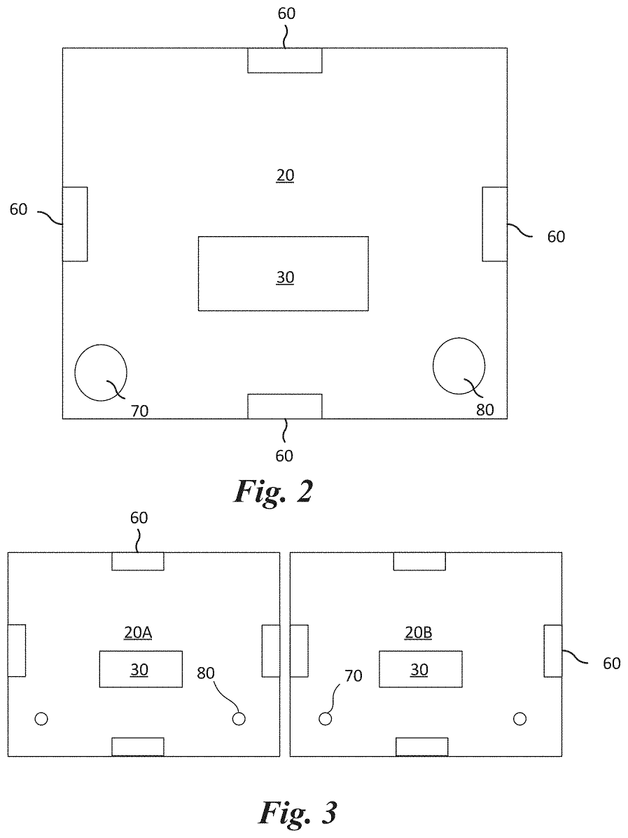

FIG. 2 illustrates one LED display panel 20 of the multi-panel modular preassembled display unit 10 illustrated in FIG. 1. The LED display panels 20 are electrically connected together for data and for power using the input cable connector 70 and the output cable connector 80. Additionally, the LED display panels 20 may also include cables connected through these connectors. The endpoint device or connector is a socket or alternatively a plug. Each modular LED display panel 20 is capable of receiving input from a preceding modular LED display panel and providing an output to a succeeding modular LED display panel.

FIG. 3 illustrates two display panels 20A and 20B next to each other, which may be connected such that the output cable connector 80 of the left display panel 20A is connected with the input cable connector 70 of the next display panel 20B. As discussed above, the connection may take a variety of forms and is, therefore, not specifically illustrated in FIG. 3. If connected together with cables, a sealing cover may lock the two cables together to provide a waterproof interconnection.

FIGS. 2 and 3 further illustrate each LED display panel 20 having a data controller 30. The data controller 30 comprises circuitry and processing capabilities to receive signal and data inputs, and after the signal processing determines the portion of the image frame of the entire image to display by the LED display panel.

Each LED display panel 20 further comprises one or more sensors 60. The sensor 60 enables the LED display panel 20 to determine whether another LED display panel 20 is located above, below, or on either side. In one embodiment, a sensor 60 may be a pressure sensor configured to sense pressure or contact from an adjacent LED display panel 20. In another embodiment, a sensor 60 may include radio frequency identification (RFID) means for sensing the relative locations of other LED display panels 20. In yet another embodiment, a sensor 60 may include other electromagnetic transceiver capabilities to determine the locations of other LED display panels 20. The information received by each sensor 60 may be sent to the data controller 30 of the same LED display panel 20.

In an embodiment, the data controller 30 sends the information from its sensor 60 to other LED display panels 20 through the input cable connector 70 and the output cable connector 80. Similarly, the data controller 30 may also receive information from any of the sensors 60 of other LED display panels 20 through the input cable connector 70 and the output cable connector 80. In some embodiments, the data controller 30 analyzes the information from its sensor 60 and any information the data controller 30 has received from other LED display panels 20 before sending more sensor information to other LED display panels 20. The data controller 30 may make an initial determination of the arrangement and/or dimensions of the preassembled display unit 10 as well as the location of its LED display panel 20 within that arrangement in order to send that initial determination to other LED display panels 20. After sensor or arrangement information has been sent to all of the LED display panels 20, each data controller 30 of the LED display panels 20 is then able to make a final determination of the arrangement and dimensions of the preassembled display unit 10 as well as the location of its LED display panel 20 within that arrangement.

In another embodiment, the sensor 60 of the LED display panel 20 may communicate with one or more sensors 60 of other LED display panels 20. The data controller 30 of the LED display panel 20 may then receive that information from its corresponding sensor 60. The communication may occur through the input cable connector 70 and the output cable connector 80, or separately. The data controller 30 may then use that information to determine the arrangement and dimensions of the preassembled display unit 10. Alternatively, the sensors 60 of multiple, or even all, of the LED display panels 20 may together determine the arrangement and dimensions of the preassembled display unit 10. Each sensor may then communicate that information to its corresponding data controller 30. As discussed above, the data controller 30 may use the information from the sensor(s) 60 to determine its portion of the image to display from the entire image.

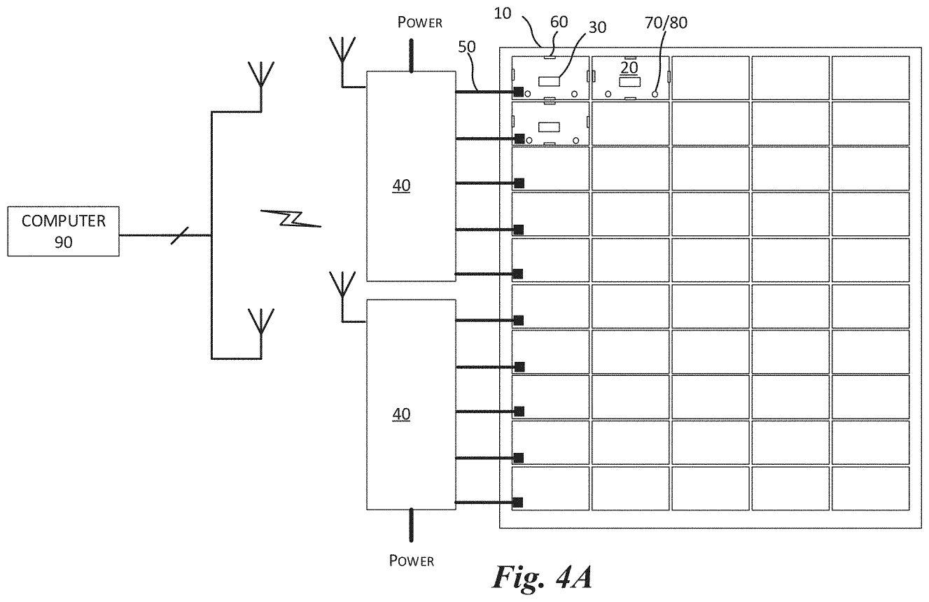

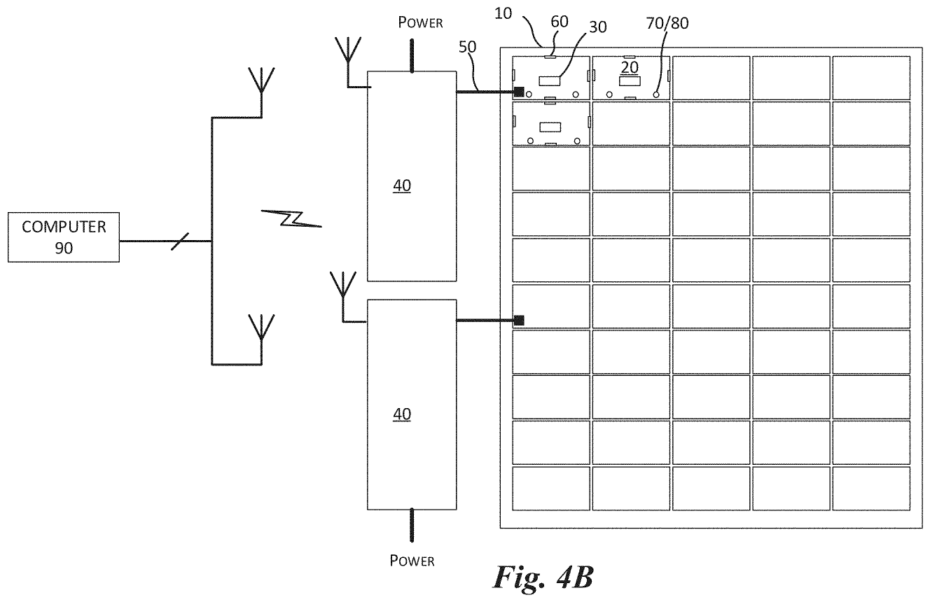

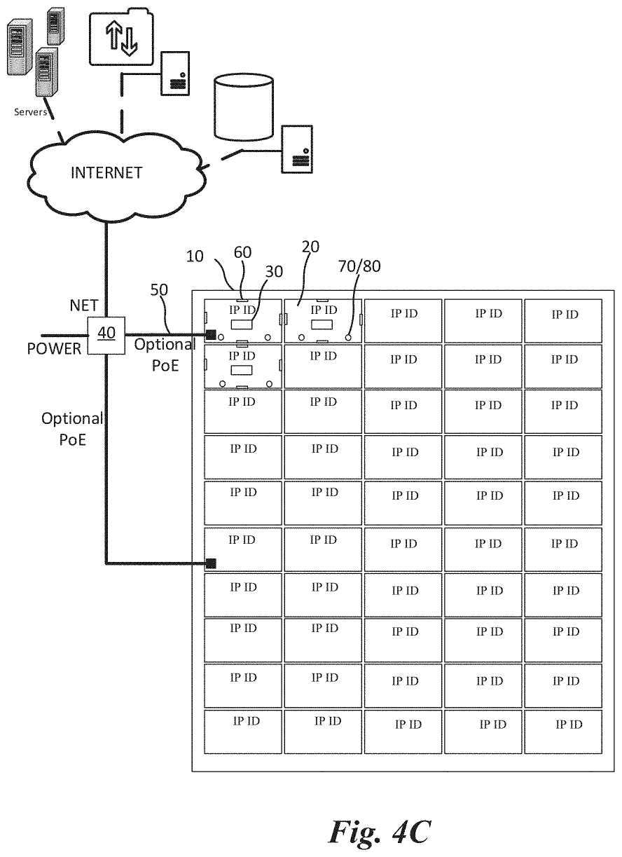

FIGS. 4A-4C illustrate several alternative embodiments for a modular multi-panel display system comprising a plurality of LED display panels 20 connected together using the aforementioned connectors in one type of arrangement. It should be noted that each LED display panel 20 includes a data controller 30 and a sensor 60 although not necessarily shown throughout the figures.

FIG. 4A illustrates an alternative embodiment, in which the receiver box 40 has wireless connectivity and receives the input data signal from the computer 90. The receiver box 40 may include wired data connection as described in FIG. 1, as well as the wireless data connection. In both embodiments, the input data signal is sent to one or more first LED display panels 20 as described in FIG. 1, which is then passed to the other LED display panels 20 through the first and second connectors 70 and 80.

FIG. 4B illustrates an embodiment of the present invention in which the display panels 20 are connected serially (e.g., daisy chained). As such, the input data signal is sent from the computer 90 to the receiver box 40 to one or more first LED display panels 20 in any manner as described in FIGS. 1 and 4A, which is then passed to the other LED display panels 20 serially through the first and second connectors 70 and 80. In one or more embodiments, the display panels 20 may also be powered using a serial connection.

In another embodiment, the receiver box 40 may simply connect the first LED display panel 20 of the display unit 10 with an interconnect (TCP/IP) port. The first LED display panel 20 may include an identifier for the whole system so that the display system advertises a single IP address. For example, the IP address of the preassembled display unit 10 may be identified from the first LED display panel 20. The remaining LED display panels 20 may be daisy chained or connected as described in previous embodiments.

The data controller 30 for each LED display panel 20 identifies and processes the portion of the media that is to be displayed at that LED display panel 20 from the data signal input that includes all the media for all the panels in the chain as described above in previous embodiments.

The first LED display panel 20 in the series of panels includes a unique IP address. Thus, when connected to the internet, the network card at the first display panel 20 receives the data to be displayed by all the panels. The remaining panels use the data processed through the network card at the first network. The remaining panels have to be calibrated so that they know which portion of the data is to be displayed by that particular LED display panel 20.

In yet another embodiment, the interface circuit may include a wireless card to receive the IP address or data signal input over a communication network, such as 3G, 4G, 4G LTE, 5G, or the like.

In an alternative embodiment, the receiver box 40 is a router coupled between the LED display panels 20 and the internet. The router may be coupled to a plurality of LED display panels 20, where each panel has its own network interface card each thereby having its unique media access control (MAC) address.

In some embodiments, the first LED display panel 20 may include the router—i.e., the router may be integrated into the first LED display panel 20. The devices within the local area of the router may now be individually addressed using the LED display panels' 20 respective MAC addresses. Accordingly, packets destined to each panel are routed by the router. In this embodiment, the LED display panels 20 within the preassembled display unit 10 may be served from different locations. For example, a larger part of the screen may show an advertisement from a media server whereas a lower portion may show the temperature from a weather server or a sports score from a sports network server.

FIG. 4C illustrates an alternative embodiment of the present invention in which each display panel has a unique IPV6 IP address.

In this embodiment, each LED display panel 20 of the preassembled display unit 10 has a unique IP address, for example, an IPV6 IP address. The media to be displayed may be split at the source of a single media server or may be obtained from multiple media servers through the internet. For example, different portions of the preassembled display unit 10 may be leased to a different company displaying its own content. This embodiment enables multiple users to share a single display board. For example, an expensive display location may be shared in time or space by multiple companies reducing their costs while improving effectiveness of the display. The LED display panels 20 may be powered via the connector 50 individually or through Power over Ethernet technologies using cats, cat6 cables.

It should be noted that a person of ordinary skill in the art would understand that the variations described and illustrated in FIGS. 1 and 4A through 4C may be combined to form other embodiments that are not specifically illustrated in the figures.

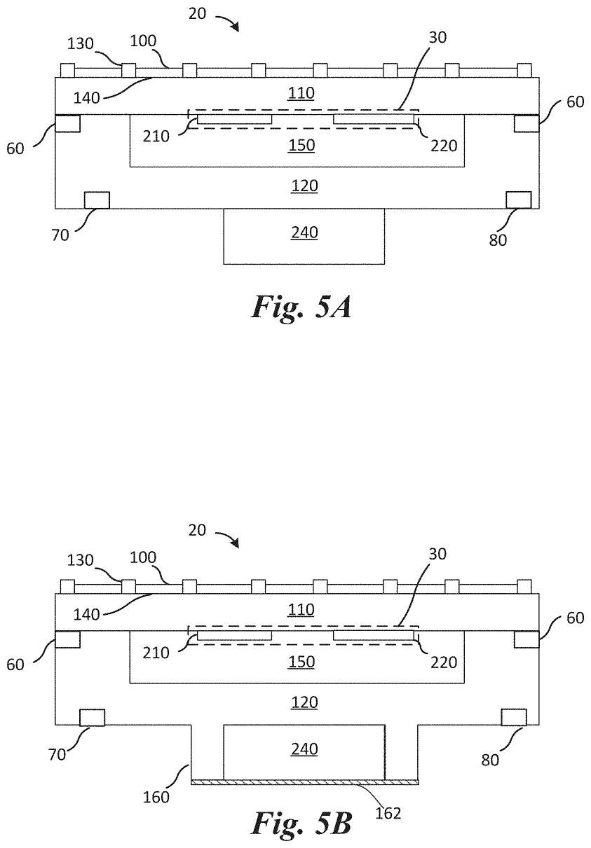

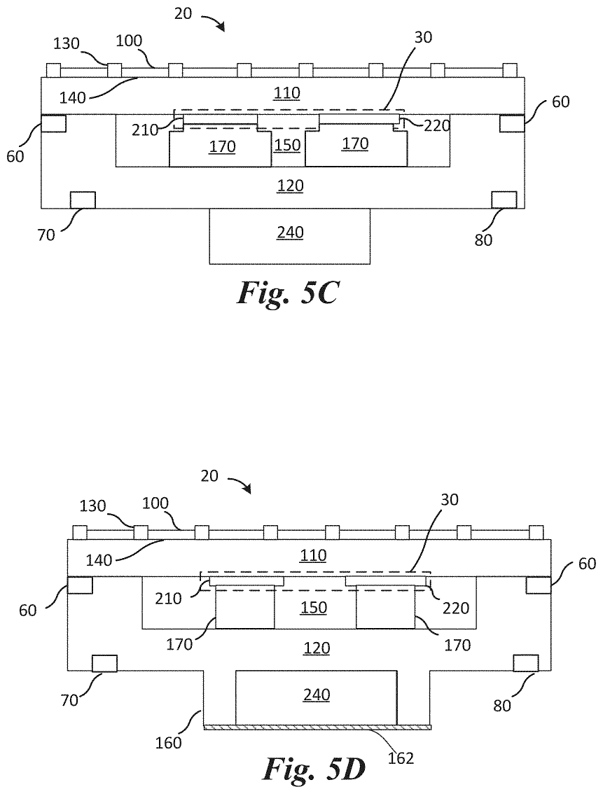

FIGS. 5A-5D illustrate cross-sectional schematic views of the LED display panel 20.

Referring to FIG. 5A, the modular LED display panel 20 comprises a plurality of LEDs 100 mounted on a front side of one or more printed circuit boards (PCBs) 110, which are housed within an enclosure or casing 120. The casing 120 may comprise aluminum alloys, plastic such as thermally conductive industrial plastic, titanium alloys, magnesium alloys, carbon fiber, and others so that it will be about 50% lighter than typical (steel) casings.

As will be discussed below, all components of the data controller 30 are mounted, such as by soldering, directly onto a back side of the one or more PCBs. A silicone layer (shown in later figures) may be disposed over front and back sides of the PCB 110. A framework of louvers 130 is attached to the PCB 110 using an adhesive 140, which further prevents moisture from reaching the PCB. However, the LEDs 100 are directly exposed to the ambient in the direction of light emission. The LEDs 100 being packaged are themselves water repellent and therefore are not damaged even if exposed to water. The louvers 130 rise above the surface of the LEDs and help to minimize reflection and scattering of external light, which can otherwise degrade the quality of light output from the LEDs 100.

The PCB 110 is attached to a mounting, which may be the casing 120 attached with standoffs as described below (standoffs and ridges not shown individually). An inner region for heat dissipation 150 is shown as space between the circuit components attached to the PCB 110 and the casing 120. The heat dissipation may occur as described below.

The data controller 30 comprises an interface circuit 200 (shown in later figures), a data processing circuit 210, a data rendering circuit 220, and a sensor control circuit 230 (shown in later figures), which are each mounted directly onto the PCB 110. The data processing circuit 210 may be a single chip in one embodiment. The data rendering circuit 220 may be a single chip in one embodiment or multiple chips in another embodiment. Similarly, each of the other components may comprise one or more chips. The data processing circuit 210 may be configured to receive the input data signal and any sensor information to determine the portion that its corresponding LED display panel 20 needs to output of the entire media display as discussed above.

The data processing circuit 210 may be configured to decode the portion of the input data signal to be displayed. In addition, the data rendering circuit may be configured to map that portion of the input data signal to a corresponding subset of the LEDs 100. That is, the data rendering circuit 220 may be configured to process the received media portion from the data processing circuit 210 and control the operation of the individual LEDs 100. For example, the data rendering circuit 220 may determine the color of the LED to be displayed at each location (pixel). Similarly, the data rendering circuit 220 may determine the brightness at each pixel location, for example, by controlling the current supplied to the LED. As discussed above, the LED display panel 20 further comprises sensors 60, which may be embedded within the casing 120. The sensors 60 may be coupled to sensor control circuits 230 (not shown), which may also be mounted on the PCB 110.

The design of the air gap within the cavity may be optimized so that heat is conducted out more efficiently. The PCB 110 is designed to efficiently extract heat from the circuit components to the region for heat dissipation 150. As such, the heat may dissipate laterally 150A and radially 150B. As described previously, the casing 120 of the LED display panel 20 has openings through which input cable connector 70 and output cable connector 80 may be attached. The connectors may have sockets or plugs for connecting to an adjacent panel.

A power supply circuit 240 may be mounted over the casing 120 for powering the LEDs 100 in one embodiment. The power supply circuit 240 may comprise a power converter for converting AC to DC, which is supplied to the LEDs 100. Alternatively, the power supply circuit 240 may comprise a down converter that down converts the voltage suitable for driving the LEDs 100. For example, the down converter may down convert a DC voltage at a first level to a DC voltage at a second level that is lower than the first level. This is done so that large DC currents are not carried on the power cables. The power supply circuit 240 is configured to provide a constant DC current to the LEDs 100.

Examples of down converters (DC to DC converters) include linear regulators and switched mode converters such as buck converters. In further embodiments, the output from the power supply circuit 240 is isolated from the input power. Accordingly, in various embodiments, the power supply circuit 240 may comprise a transformer. As a further example, in one or more embodiments, the power supply circuit 240 may comprise a forward, half-bridge, full-bridge, push-pull topologies.

The power supply circuit 240 may be placed inside a Faraday cage to minimize RF interference to other components. The power supply circuit 240 may also include a control loop for controlling the output current. In various embodiments, the LED display panel 20 is sealed to an IP 65 or higher standard, e.g., IP 65, IP 66, IP 67, or IP 68. As discussed herein, other ratings are possible.

FIG. 5B illustrates an alternative embodiment in which the power supply circuit 240 is disposed within the casing. In this embodiment, the power supply circuit 240 may be mounted within an extension region 160 of the casing 120. The casing 120 may include a highly thermally conductive cover 162 to protect the power supply circuit 240. In one embodiment, the thermally conductive cover may have a thermal conductivity that is at least ten times the thermal conductivity of the casing 120. In another embodiment, the thermally conductive cover may have a thermal conductivity that is at least one hundred times the thermal conductivity of the casing 120.

FIG. 5C illustrates a top-down cross-sectional view of an alternative embodiment with various components in the LED display panel 20. The embodiment depicted in FIG. 5C is similar to that depicted in FIG. 5A except that FIG. 5C also includes heat conducting structure 170. The heat conducting structure 170 may be placed over some or all of the components of the data controller 30, such as the data processing circuit 210 and the data rendering circuit 220, in order for the heat to be drawn away from the circuit components and dissipate more effectively. The heat conducting structure 170 may be designed with a thermally conductive material that has a higher thermal conductivity than the casing 120. In one embodiment, the heat conducting structure 170 may have a thermal conductivity that is at least ten times the thermal conductivity of the casing 120. In another embodiment, the heat conducting structure 170 may have a thermal conductivity that is at least hundred times the thermal conductivity of the casing 120. In various embodiments, the heat conducting structure 170 may comprise metallic materials with high thermal conductivity such as aluminum, copper, silver, and others.

FIG. 5D illustrates an alternative embodiment to FIG. 5C in which the power supply circuit 240 is disposed within an extension region 160 of the casing 120.

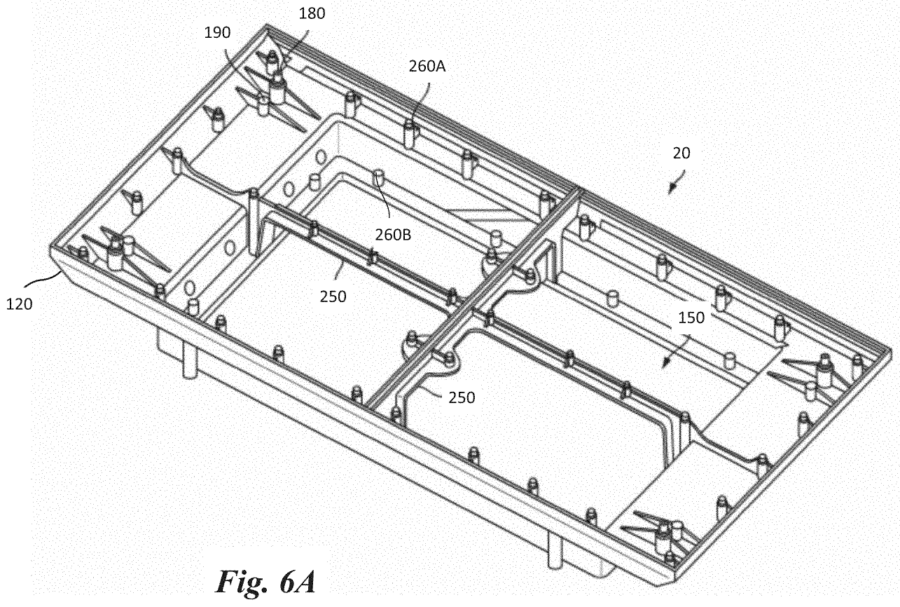

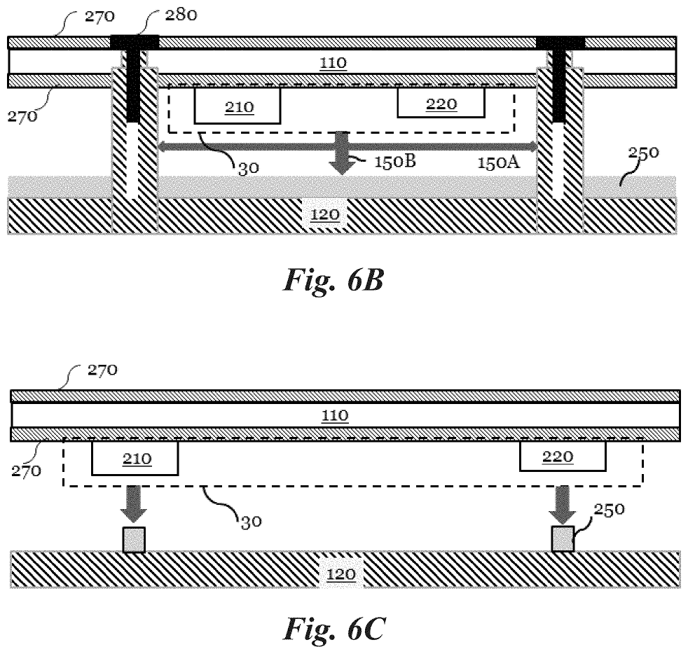

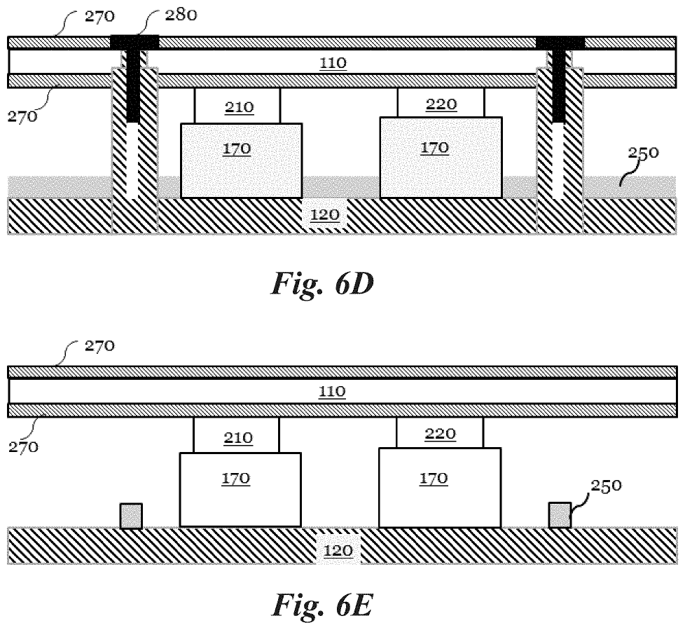

FIGS. 6A-6E illustrate additional views of the panel in accordance with an embodiment of the present invention, wherein FIG. 6A is a projection view of a casing and FIGS. 6B-6E are magnified views showing portions of the panel.

For a better understanding of the design of the casing, an example illustration of the casing is provided in FIG. 6A. As shown in FIG. 6A, the casing 120 (which may be also referred to as a housing or mounting) defines a region for heat dissipation 150 (which may also be referred to as a recess or cavity) between the PCB and the back side of the casing 120. Structural cross-members (ridges 250) may be used to provide support to a substrate (e.g., the PCB 110 of FIG. 5A). The ridges 250, as well as other areas of the casing 120, may include standoffs 260A and 260B against which the PCB 110 can rest when placed into position. As shown, the standoffs 260A and 260B may include a relatively narrow tip section that can be inserted into a receiving hole in the back of the PCB 110 and then a wider section against which the PCB 110 can rest.

The casing 120 may also include multiple extensions 180 (e.g., sleeves) that provide screw holes or locations for captive screws that can be used to couple the substrate to the casing 120. Other extensions 190 may be configured to receive pins or other protrusions from an attachment plate or point, which secures the casing 120 to an external mechanical support such as the frame to which all the LED display panels are attached to. Some or all of the extensions 190 may be accessible only from the rear side of the casing 120 (e.g. through a back cover that defines a back surface of the casing 120 and that encloses the region for heat dissipation 150) and so are not shown as openings in FIG. 6A. As shown in FIG. 6A, the casing 120 may include beveled or otherwise non-squared edges. This shaping of the edges enables adjacent display panels 20 to be positioned in a curved display without having large gaps appear as would occur if the edges were squared.

FIGS. 6B-6D illustrate a magnified cross-sectional view of the casing with a PCB no. Referring to FIGS. 6B-6D, the PCB 110 runs along a front side of the LED display panel 20 and a casing 120 along a back side, each of which also having a front and back side. The LEDs (not shown in these figures) are attached to the front side of the PCB 110. The front and back sides of the PCB 110 are coated with a silicone layer 270, which serves to protect the PCB 110 and internal components of the LED display panel 20 from internal and/or external elements, such as precipitation, moisture, etc.

The PCB 110 is attached to the casing 120 using standoffs 260A and 260B. FIG. 5A illustrates standoff 260A extending from the front side of PCB 110 to the casing 120. And FIG. 5B illustrates standoff 260B extending from the back side of PCB 110 to the casing 120. The standoffs 260A and 260B may be the same material and contiguous with the casing 120. As such, the standoffs 260A and 260B may be thermally conductive. Although in one embodiment, the standoffs 260A and 260B are made of the same material as the rest of the casing 120, in some embodiments, they may be made of a material that is more thermally conductive than the casing 120. Alternately, the structure of the standoffs 260A and 260B may be designed to extract more heat towards outside of the casing 120. FIGS. 6B and 6D illustrate a screw 280 extending through the silicone layer 270 on the front side of the PCB 110, through the PCB 110, and through a portion of the standoff 260A or 260B. The screw 280 may be inserted through the PCB 110 and the standoff 260A or 260B such that the head of the screw 280 is substantially level with the silicone layer 270 disposed over the front side of the PCB 110.

A ridge 250 extends from the casing 120 into the space between the casing 120 and the PCB 110. Ridges 250 may be designed to connect adjacent standoffs 260A or 260B. As illustrated in FIGS. 6B and 6C, heat dissipation 150 can flow laterally 150A and/or radially 150B from circuitry elements on the PCB 110 throughout the space between the PCB 110, casing 120, and standoffs 260A and 260B. For example, LEDs disposed on the front side of the PCB no generate heat that travels through silicone layers 270 and the PCB 110 before reaching the space between the various components. In addition, circuit elements, such as the data controller 30, disposed on the back side of the PCB 110 also generate heat that travels through the space between the various components. The ridges 250 further provide channels for heat to dissipate in the spaces between the components.

FIGS. 6D-6E illustrate alternative magnified cross-sectional views of the display panel in accordance with alternative embodiments of the present invention. In contrast to FIGS. 6B-6C, the embodiments of FIGS. 6D-6E include heat conducting structure 170 as previous described. The design of the casing 120 may be modified to include the heat conducting structure 170. Referring to FIG. 6D, the ridges 250 are modified to accommodate the heat conducting structure 170. In a different embodiment illustrated in FIG. 6E, the heat conducting structure 170 is disposed between adjacent ridges 250.

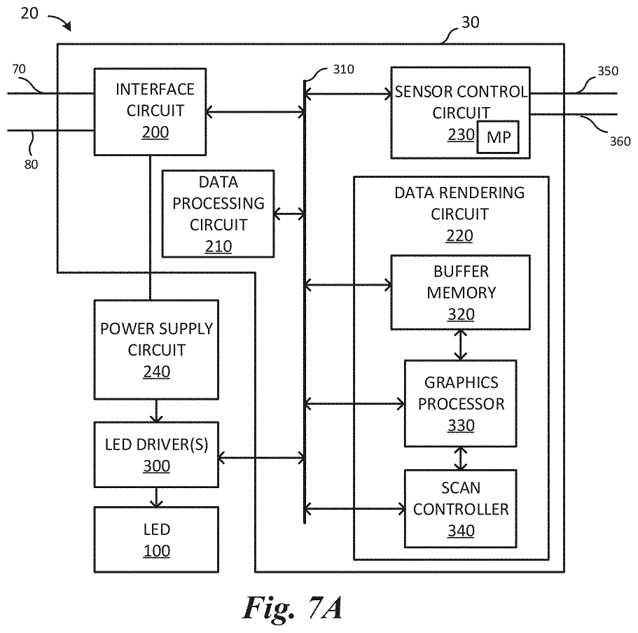

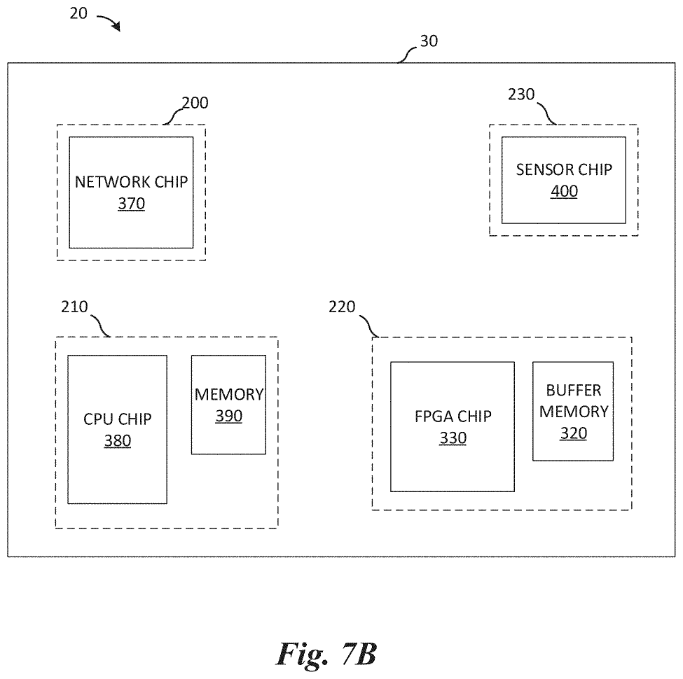

FIG. 7A illustrates a system diagram schematic of the display panel in accordance with an embodiment of the present invention.

Referring to FIG. 7A, the LED display panel 20 includes a data controller 30 attached directly to the PCB as well as LED driver(s) 300, and LEDs 100. The power supply circuit 240 comprising the power converter may be mounted on the PCB 110 in some embodiments. In other embodiments, the power supply circuit 240 may be mounted on a separate board. As shown, a data and power signal received at the input cable connector 70 is processed at an interface circuit 200. The incoming power is provided to the power converter of the power supply circuit 240, which provides the appropriate power to LED drivers 300. Another output from the incoming power is provided to the output cable connector 80. This provides redundancy so that even if a component in the LED display panel 20 is not working, the output power to the next panel is not disturbed. Similarly, the output cable connector 80 includes all the data packets being received in the input cable connector 70. The LED drivers 300 are attached at different locations on the PCB 110 and are configured to control a small array of LEDs, e.g., a row of twelve red LEDs. Each of the LED drivers 300 may be configured to provide a constant current with a constant pulse width to a corresponding subset of the LEDs 100.

The interface circuit 200 provides the input data signal to the data processing circuit 210 and the data rendering circuit 220 through a receiver bus 310 and handles the networking stack. In some embodiments, the processors of the data processing circuit 210 and the data rendering circuit 220 are provided on a single chip attached directly to the PCB 110. In some embodiments, the interface circuit 200 also provides the input data signal to the sensor control circuit 230 through the receiver bus 310. The data rendering circuit 220 may include a buffer memory 320, a graphics processor 330, and/or a scan controller 340. In some embodiments, the interface circuit 200 provides the input data signal only to the data processing circuit 210, which provides only the portion to be output by the corresponding LED display panel 20 to the data rendering circuit 220. In an embodiment, the data processing circuit 210 provides all the particular portion of the input data signal to the graphics processor 330. For example, the graphics processor 330 may perform any decoding of the received portion of the input data signal. The graphics processor 330 may use the buffer memory 320 or frame buffer as needed to store media packets during processing. The graphics processor 330 processes only the portion of the image that will be displayed by that particular LED display panel 20 and not the entire image.

A scan controller 340, which may include an address decoder, may receive the media to be displayed from the graphics processor 330 and identifies individual LEDs in the LEDs 100 that need to be controlled. The scan controller 340 may include a color circuit to determine an individual LED's color, brightness, refresh time, and other associated parameters to generate the display. In one embodiment, the scan controller 340 may provide this information to the LED driver 300, which selects the appropriate current for the particular LED. The scan controller 340 may be further configured to adjust the LEDs such that two or more LEDs with same color and brightness values are displayed the same.

Alternatively, in one embodiment, the scan controller 340 may interface directly with the LEDs 100. For example, the LED driver 300 provides a constant current to the LEDs 100 while the scan controller 340 controls the select line needed to turn ON or OFF a particular LED. Further, in various embodiments, the scan controller 340 may be integrated into the LED driver 300.

In an embodiment, a sensor control circuit 230 receives sensor information from a sensor 60 on the LED display panel 20 (not shown in FIGS. 6A-6E) as discussed above. In addition, the sensor control circuit 230 may receive sensor information from one or more other sensors 60 corresponding to other LED display panels through either connectors 70/80 or input/output 350/360. The sensor control circuit 230 may also include a microprocessor MP. The sensor control circuit 230 receives the sensor information inputs to make a determination of the arrangement and/or dimensions of the preassembled display unit 10 as well as the location of its LED display panel 20 within that arrangement. The sensor control circuit 230 may also send sensor information and its initial or final determination to its sensor(s) 60 or to sensors 60 on other LED display panels 20 through output 360.

Alternatively, the sensor control circuit 230 may send the sensor information and/or its initial and final determination to the data processing circuit 210 and/or the data rendering circuit 220. In embodiments in which the sensor control circuit 230 sends only sensor information to either of those components without a final determination, then either of those components (i.e., the data processing circuit 210 or the data rendering circuit 220) may make the final determination of the arrangement and/or dimensions of the preassembled display unit 10 as well as the location of its LED display panel 20 within that arrangement. In an embodiment, a combination of the sensor control circuit 230, the data processing circuit 210, and/or the data rendering circuit 220 may make any one of the determinations of the arrangement and dimensions of the preassembled display unit 10 and the location of the particular LED display panel 20 within that arrangement.

FIG. 7B illustrates a system diagram schematic of the physical components of the above-described data controller 30 and how those components may be mounted onto the back side of the PCB 110 of the LED display panel 20. As shown, the data controller 30 includes the interface circuit 200, the data processing circuit 210, the data rendering circuit 220, and the sensor control circuit 230. The interface circuit 200 includes a network chip 370, which may comprise a network switch and a network processor. The data rendering circuit 220 includes a CPU chip 380 and a first memory 390. The data rendering circuit 220 includes a processing chip, such as a field-programmable gate array (FPGA) chip 330, and a second memory, such as the buffer memory 320. The scan controller 340 as described above with FIG. 7A may be implemented within the FPGA chip 330. The sensor control circuit 230 includes a sensor chip 400. The components are electrically connected to one another as described in connection with FIG. 7A. The data controller 30 may include additional chips, memory, or other circuitry elements not specifically shown in FIGS. 7A and 7B.

Embodiments of the invention provide an LED display panel, each of which provides a completely self-contained building block that is lightweight. These displays are designed to protect against weather, without a heavy cabinet, which is a common waterproof protective enclosure protecting all the panels. The panel can be constructed of aluminum alloys, plastic such as thermally conductive industrial plastic, titanium alloys, magnesium alloys, carbon fiber, and others so that it will be about 50% lighter than typical panels. The lightweight design allows for easier installation and maintenance, thus lowering total cost of ownership.

In various embodiments, each of the display panels has an ingress protection (IP) rating that is greater than IP65. In certain embodiments, the display is IP 67 rated and therefore waterproof and corrosion resistant. Because weather is the number one culprit for damage to LED displays, and IP 67 rating provides weatherproofing with significant weather protection. These panels are completely waterproof against submersion in up to 3 feet of water. In other embodiments, the equipment can be designed with an IP 68 rating to operate completely underwater. In lower-cost embodiments where weatherproofing is not as significant, the panels can have an IP 65 or IP 66 rating.

Embodiments of the invention provide building block panels that are configurable with future expandability. These displays can offer complete expandability to upgrade in the future without having to replace the entire display. Installation is fast and easy with very little down-time, which allows any electronic message to be presented more quickly.

In some embodiments, the display panels are “hot swappable,” whereby a defective panel can be removed when the remaining panels of the display system are still powered and displaying data. By removing one screw in each of the four corners of the panel, servicing the display is fast and easy. Since a highly-trained, highly-paid electrician or LED technician is not needed to correct a problem, cost benefits can be achieved.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A light-emitting diode (LED) display panel comprising:
a printed circuit board (PCB) comprising a first side and a second side;
a plurality of LEDs attached to the first side of the PCB;
a plurality of drivers attached to the PCB, each of the plurality of drivers configured to control a subset of the plurality of LEDs; and
a data controller attached to the second side of the PCB, the data controller configured to receive an input data signal and determine a portion of the input data signal to be displayed by the plurality of LEDs.

2. The LED display panel of claim 1, wherein the data controller comprises a data rendering circuit configured to provide LED parameters to the plurality of drivers to control only the plurality of LEDs attached to the PCB.

3. The LED display panel of claim 1, wherein the data controller and the plurality of drivers are directly attached to the second side of the PCB.

4. The LED display panel of claim 1, wherein each of the plurality of drivers is configured to provide a constant current with a constant pulse width to a corresponding subset of the plurality of LEDs.

5. The LED display panel of claim 1, wherein the data controller comprises a data processing circuit configured to decode the portion of the input data signal to be displayed and a data rendering circuit configured to map the portion of the input data signal to be displayed to corresponding LEDs of the plurality of LEDs.

6. The LED display panel of claim 5, wherein the data rendering circuit further comprises a scan controller configured to determine color and brightness to be displayed at each of the mapped corresponding LEDs.

7. The LED display panel of claim 6, wherein the scan controller is further configured to adjust the mapped corresponding LEDs such that two of the mapped corresponding LEDs with same color and brightness values are displayed the same.

8. The LED display panel of claim 1, further comprising a sensor circuit, the sensor circuit configured to determine a location of the LED display panel with respect to one or more other LED display panels.

9. A display system comprising:
a first printed circuit board (PCB);
a first plurality of light-emitting diodes (LEDs) attached to a first side of the first PCB;
a first plurality of drivers attached to the first PCB, each of the first plurality of drivers configured to control a subset of the first plurality of LEDs;
a first data controller attached to a second side of the first PCB, the first data controller configured to receive an input data signal and determine a first portion of the input data signal to be displayed by the first plurality of LEDs and control the first plurality of drivers;
a second PCB different from the first PCB;
a second plurality of LEDs attached to a first side of the second PCB;
a second plurality of drivers attached to a second side of the second PCB, each of the second plurality of drivers configured to control a subset of the second plurality of LEDs; and
a second data controller attached to the second side of the second PCB, the second data controller configured to receive the input data signal and determine a second portion of the input data signal to be displayed by the second plurality of LEDs and control the second plurality of drivers.

10. The display system of claim 9, wherein the first data controller is configured to provide a first set of LED parameters to the first plurality of drivers to control only the first plurality of LEDs attached to the first PCB, and the second data controller is configured to provide a second set of LED parameters to the second plurality of drivers to control only the second plurality of LEDs attached to the second PCB.

11. The display system of claim 9, wherein the first plurality of drivers and the first data controller are directly attached to the second side of the first PCB, and the second plurality of drivers and the second data controller are directly attached to the second side of the second PCB.

12. The display system of claim 9, wherein each of the first plurality of drivers is configured to provide a constant current with a constant pulse width to the corresponding subset of the first plurality of LEDs attached to the first PCB, and wherein each of the second plurality of drivers is configured to provide the constant current with the constant pulse width to the corresponding subset of the second plurality of LEDs attached to the second PCB.

13. The display system of claim 9, wherein:
the first data controller comprises:
a first data processing circuit configured to decode the first portion of the input data signal to be displayed; and
a first data rendering circuit configured to map the first portion of the input data signal to be displayed to corresponding first LEDs of the first plurality of LEDs; and
the second data controller comprises:
a second data processing circuit configured to decode the second portion of the input data signal to be displayed; and
a second data rendering circuit configured to map the second portion of the input data signal to be displayed to corresponding second LEDs of the second plurality of LEDs.

14. The display system of claim 13, the first data controller further comprising a first data rendering circuit configured to determine color and brightness to be displayed at each of the mapped corresponding first LEDs attached to the first PCB, and the second data controller further comprising a second data rendering circuit configured to determine color and brightness to be displayed at each of the mapped corresponding second LEDs attached to the second PCB.

15. The display system of claim 14, the first data rendering circuit is further configured to adjust the mapped corresponding first LEDs attached to the first PCB such that two of the mapped corresponding first LEDs attached to the first PCB with same color and brightness values are displayed the same, and the second data rendering circuit is further configured to adjust the mapped corresponding second LEDs attached to the second PCB such that two of the mapped corresponding second LEDs attached to the second PCB with same color and brightness values are displayed the same.

16. The display system of claim 9, further comprising:
a first sensor attached to the first PCB and a second sensor attached to the second PCB; and
a first sensor circuit attached to the first PCB and connected to the first sensor and a second sensor circuit attached to the second PCB and connected to the second sensor, the first sensor circuit and the second sensor circuit configured to determine a physical configuration of the first plurality of LEDs and the second plurality of LEDs with respect to one another.

17. The display system of claim 16, wherein each of the first data controller and the second data controller is configured to receive a data signal identifying the physical configuration.

18. A LED display panel, comprising:
a printed circuit board (PCB);
a plurality of light-emitting diodes (LEDs) attached to a first side of the PCB;
a plurality of drivers attached to the PCB, each of the plurality of drivers configured to control a subset of the plurality of LEDs;
a data controller attached to a second side of the PCB, the data controller configured to receive an input data signal, the data controller comprising:
a data processing circuit configured to determine a portion of the input data signal to be displayed by the plurality of LEDs; and
a data rendering circuit configured to control corresponding LEDs to display a portion of the input data signal; and
a casing attached to the second side of the PCB.

19. The LED display panel of claim 18, further comprising:
a heat conducting structure attached to one or more of the data processing circuit and the data rendering circuit, the heat conducting structure being interposed between the PCB and the casing.

20. The LED display panel of claim 19, wherein the casing comprises standoffs extending perpendicularly from a major surface of the casing toward the PCB, and wherein the casing further comprises ridges extending perpendicularly from the major surface of the casing toward the PCB and connecting adjacent standoffs.
